(19) United States
(12) Patent Application Publication
(10) Pub. No.: US 2009/0120228 A1
(43) Pub. Date: May 14, 2009

(54) Industrial Robot

(76) Inventors: Jan Larsson, Vasteras (SE); Karl-Gunnar Johnsson, Vasteras (SE); Mats Olsson, Vasteras (SE); Bo Toresson, Koping (SE); Stig Persson, Vasteras (SE); Tommi Paananen, Vasteras (SE)

Correspondence Address: VENABLE LLP, P.O. BOX 34385, WASHINGTON, DC, 20043-9998, US

(21) Appl. No.: 11/884,074

(22) PCT Filed: Feb. 13, 2006
(86) PCT No.: PCT/SE2006/000191

§ 371 Date: Aug. 9, 2007

(30) Foreign Application Priority Data
Feb. 11, 2005 (SE) 0500340-5

(51) Int. Cl. B25J 18/00

(52) U.S. Cl. 74/490.02; 74/490.03

(57) ABSTRACT

An industrial robot including, for rotation about a first shaft and rotation about a second shaft, a drive package with a motor and a gear between an output shaft of the motor and the first and second shafts, respectively. The respective gear is a multistage gear transmission with parallel gear wheel axes and one of the gear wheels of the gear is secured to the first and second shafts, respectively. The gear for the second shaft is arranged above the gear of the first shaft and, viewed from above in the direction of the first shaft, is partly covering the gear of the first shaft.

### FIELD OF THE INVENTION AND BACKGROUND ART

The present invention relates to an industrial robot with a fixed base, a frame pivotally connected thereto about a first axis, a lower arm, one end of which is pivotally connected to the frame about a second axis, and an upper arm, one end of which is pivotally connected to the other end of the lower arm about a third axis.

The invention relates to industrial robots for any conceivable use, such as, for example, for welding, painting, removal of goods, etc.

The term “fixed base” is to be interpreted as being fixed on the base on which the robot rests, but the latter base may very well be movable, for example be in the form of a car running on rails. Said three axes usually extend, respectively, vertically (first), horizontally (second) and horizontally parallel to the second one, but directions completely different from these are feasible. With regard to the designation “horizontal” and “vertical” above and in the following description, reference is made to the case where the robot is standing on a horizontal base.

The number of axes is often six in such an industrial robot in order to achieve maximum freedom of movement for a gripping claw, a spray nozzle, or the like, mounted at the outer end of the upper arm via a so-called wrist. However, the invention also includes industrial robots with fewer axes, and it is quite possible for the robot to exhibit the above-mentioned three axes only.

A robot of this type comprises a drive package with a motor and a gear between the output shaft of the motor for achieving rotation of the frame relative to the base about the first axis and a similar drive package for rotating the lower arm relative to the frame about the second axis.

In hitherto known robots of this kind, these drive packages are arranged adjacent to each other, which entails a relatively large extent of the robots in a horizontal direction, and the relatively large distance between said axes in the horizontal direction implies that the free area that the robot needs to be able to work without bumping into obstacles becomes large, that is, such robots must be located at a relatively long distance from each other and hence require a large floor area.

### SUMMARY OF THE INVENTION

It is the object of the present invention to provide an industrial robot of the kind described above, which improves the possibilities of reducing the floor area required for such a robot.

This object is solved by means of the invention by providing such a robot, in which the respective gear is a multistage gear transmission with parallel gear wheel axes and one of the gear wheels of the gear is secured with respect to the first and second axes, respectively, and the gear for the second axis is arranged above the gear of the first axis and, viewed from above in the direction of the first axis, is partly covering the gear of the first axis.

In this way, the robot may be made more compact with regard to its extent in the horizontal direction, and the first and second axis will be closer to each other in the horizontal direction, which, in a decreasing direction, influences the free area that the robot needs to move across without bumping into obstacles or other robots. In this way, both gears may be arranged in one and the same housing. In addition, the very use of a multi-stage gear transmission at this location in a robot provides a possibility of taking measures for achieving elimination of play in the gear and hence a higher rigidity of the robot between the robot arms connected to the drive package in question. Such an elimination of play is not possible, neither with a single-stage gear transmission, nor with a compact gear transmission. How this elimination of play can be achieved in practice is the object of one embodiment of the invention described below.

According to one embodiment of the invention, said gear wheel that is secured with respect to the second axis is arranged externally of and passed through by the second axis and, viewed from above in the direction of the first axis, protrudes in the radial direction essentially up to the first axis, whereby the robot may be made compact and with a reduced area requirement.

According to another embodiment of the invention, said drive packages are arranged inside said frame, which is advantageous when striving to create a compact robot. The first and second axles are advantageously hollow, which enables pulling cables sealed against the exterior through these axles.

According to another embodiment of the invention, the first and second axles open out into a common space in the frame that forms both a stand part and a housing for the gears associated with the first and second axes. In this way, said space in the frame may be simply and efficiently sealed outwardly and still be accessible through a removable housing, which constitutes another embodiment of the invention.

According to a further embodiment of the invention, also the third axle and the lower arm are hollow, and cables for controlling the movement of the robot extend from the base to the upper arm inside the base, the frame and the lower arm through said three axles in a path that is sealed relative to the exterior. This renders the robot well suited for use in aggressive environments, such as environments laden with moisture or other medium that may be detrimental to the functioning of cables and other vital parts of a robot.

It is advantageous in this context for the lower arm to comprise a housing capable of being removed for accessing the interior of the lower arm.

According to yet another embodiment of the invention, the industrial robot comprises a said drive package with a motor and a multistage gear transmission also for the third axis, and this drive package is arranged in a space in the upper arm together with a drive package with a motor and a gear for rotating the upper arm relative to the lower arm around a fourth axis parallel to the longitudinal extent of the upper arm. In this way, said space in the upper arm is advantageously sealed relative to the exterior by a removable housing, such that these vital parts of the industrial robot are protected from the effect of the external environment but are still accessible when desired.

Thus, in said space in the upper arm, there may also advantageously be arranged motors for axes arranged at the other end of the upper arm, located opposite to the connection with the lower arm, when such axes exist.

According to still another embodiment of the invention, the robot comprises so-called client cables, extending from the interior of the base to the frame through said first axle, that is, cables specific to the intended use of the robot, such as welding wires, and not belonging to cables intended for controlling the movements of the robot. Because of the type of gear that is used here, the continuous hole in said first axle may be provided with such a large cross section that there will be no problem passing such client callers through the axle. This also makes it possible to arrange inside said first axle a tube, extending in the direction of said axle, with a smaller outer diameter than the inner diameter of the axle, and to arrange said client cables in the tube and the cables intended for controlling the movement of the robot in the space between the tube and the inner wall of the shaft to tightly separate these two types of cable. This may sometimes be important, for example for client cables in the form of welding wires, in which very strong currents may flow which may influence signals and power feed in the other cables of the robot.

According to yet a further embodiment of the invention, the industrial robot exhibits, for at least one of said gears, means for eliminating any play in the last stage of the gear in that said last gear wheel, secured with respect to the respective axis, and a penultimate gear wheel meshing with said last gear wheel, exhibit wedge-like teeth in the direction of their axes of rotation and that means are arranged for spring-loaded influence of said penultimate gear wheel in the direction of said axes of rotation to mesh with said last gear wheel. This increases the precision and the evenness of the rotary motion about the axis in question, which is important when the robot is to carry out precision work. In addition, because of the wedge-like tooth shape, the elimination of play with the resultant rigidity between the robot arms in question will be maintained over time, since the teeth are worn into an increasingly better fit, and this together with the spring loading provides for very little play.

Further advantages and advantageous features of the invention will become clear from the following description and the other independent claims.

### BRIEF DESCRIPTION OF THE DRAWINGS

Embodiments of the invention, given as examples, will be described in the following with reference to the accompanying drawings, wherein:

FIG. 1 is a perspective view of an industrial robot according to one embodiment of the invention,

FIG. 2 is a very simplified view illustrating the mutual location of the gears in the drive packages for the first and second axes of the robot according to FIG. 1,

FIG. 3 is a simplified perspective view illustrating the composition of a drive package for rotation about an axis of a robot according to FIG. 1,

FIG. 4 is a simplified, partly cut-away view through the robot according to FIG. 1 illustrating possible cable pulling therethrough,

FIG. 5 is a cut-away view through the base and the frame of a robot according to the invention illustrating the cable pulling through these parts of the robot, and

FIG. 6 is a view corresponding to FIG. 5, illustrating an alternative cable pulling through the relevant parts of the robot.

### DETAILED DESCRIPTION OF EMBODIMENTS OF THE INVENTION

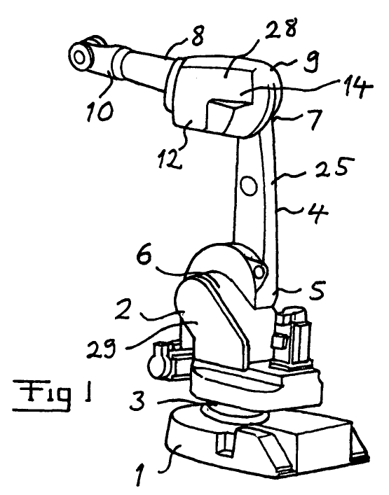

FIG. 1 illustrates an industrial robot according to the invention, said robot having a fixed base 1, the outer casing of which delimits an inner tight space for cables and electronics equipment intended both for transmission of electric power to the different motors of the robot and for signal transmission. A frame 2 is rotatably connected to the base around a vertical first axis 3 (the different axes are only schematically denoted in the figures). Further, one end 5 of a lower arm 4 is rotatably connected to the frame 2 about a horizontal second axis 6. Inside the frame 2, drive packages are arranged comprising motor and gear for both rotation of the frame relative to the base about the first axis and for rotation of the lower arm relative to the frame about the second axis.

At the other end 7 of the lower arm, one end 9 of an upper arm 8 is rotatably connected about a horizontal third axis that is parallel to the second axis. At the other end 10 of the upper arm, different types of equipment may be arranged; however, these are not relevant to the invention and will not therefore be described here.

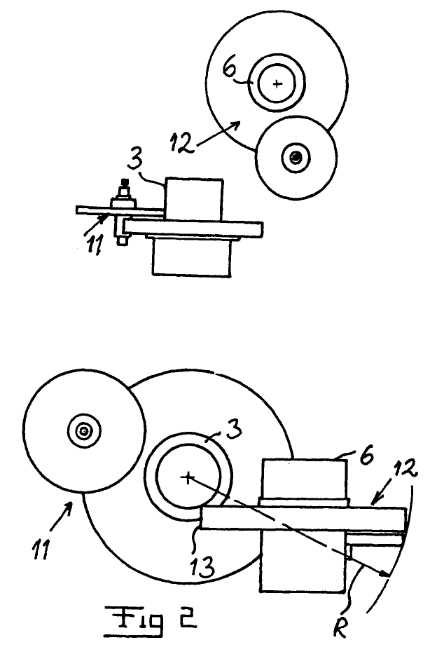

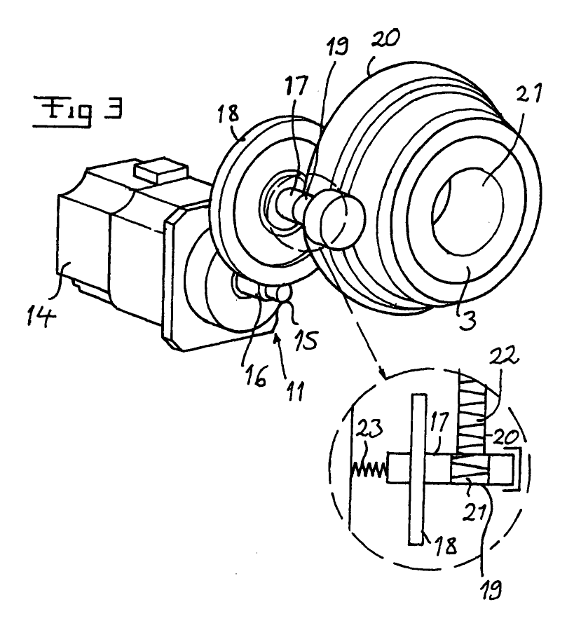

In FIG. 2, the upper part schematically illustrates the gears 11, 12 in drive packages with motor and gear between the output shaft of the motor and the first 3 and second 6 axes, respectively, in a side view in the direction of the second axis, and the lower part illustrates a view from above in the direction of the first axis. How these drive packages with gears are constructed will be described in more detail below with reference to FIG. 3. It is clear that the gear 12 for the second axis 6 is arranged above the gear 11 of the first axis 3 and, viewed from above in the direction of the first axis (lower part of FIG. 2), is partly covering the gear of the first axis, more precisely to such an extent that a last gear wheel 13 of the gear 12, which wheel is secured with respect to the second axis 6, projects, viewed from above in the direction of the first axis, in the radial direction essentially up to the first axis 3. In this way, the radius R, which describes the interference area of the robot relative to other robots and obstacles with regard to the frame, is relatively short, which is advantageous for the possibilities of arranging such robots in a tight manner or on small surfaces. In addition, the gears of the two axes may be arranged in one and the same housing. The possible compact design of the frame 2, while tightly sealing the inner space of the frame with a removable housing 29, is clear from FIG. 1. It is also clear that a housing 28 encloses a space in the upper arm, said space comprising, inter alia, a drive package of the kind described below for rotating the upper arm about the third axis.

FIG. 3 illustrates the composition of a drive package of the type that is preferably arranged for rotation about the first, the second as well as the third axis. The drive package exhibits an electric motor 14. Between the motor 14 and the axis 3 (or any of the other axes), a gear 11 is arranged for reduction of the speed of an output shaft 15 of the motor to a speed that is at least 50, preferably more than 100 times lower than the speed of the axle 3. The gear comprises a first stage in the form of a smaller gear wheel 16, arranged on the output shaft 15 of the motor, meshing with a larger wheel 18 arranged on a shaft 17. The shaft 17 is arranged to be rotatable about an axis parallel to the motor shaft in bearings (not shown).

The gear exhibits a second stage in the form of a small, so-called penultimate gear wheel 19 arranged on the shaft 17 and meshing with a large, so-called last gear wheel 20 of the gear. The large gear wheel 20 is secured to the shaft 3 which, due to the large diameter of this gear wheel, may be provided with a through-hole 21 with a relatively large cross section.

The penultimate gear wheel 19 and the last gear wheel 20 exhibit, in the direction of their axes of rotation, wedge-like teeth 21, 22, and since the shaft 17 is influenced by way of a spring 23 in the direction of its longitudinal extent, the wedge-like teeth will all the time be pressed to intimately mesh with each other to eliminate any play in this last stage of the gear.

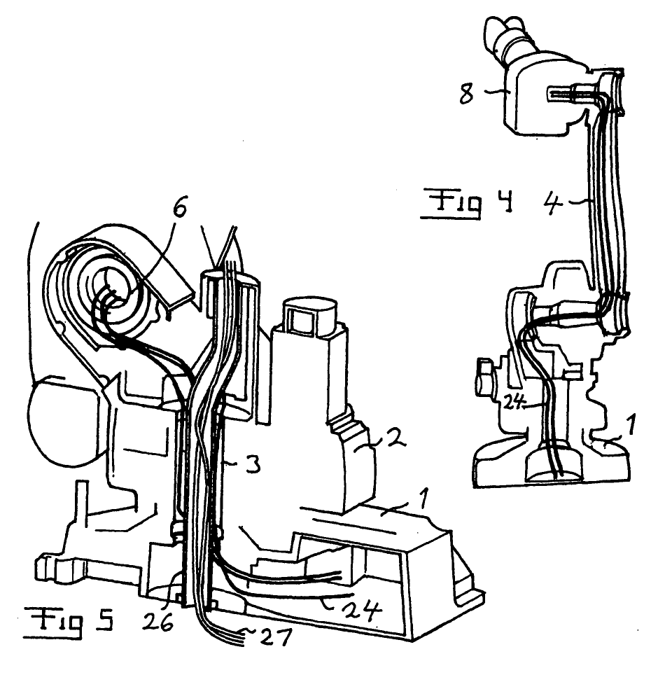

One advantage of this type of gear is that the axle in question may be provided with a hole 21 with a large cross section without the drive package becoming bulky and still possible to place inside the stand of the robot. This provides possibilities of pulling the cables of the robot through such an axle to protect them against the impact of the environment externally of the robot. FIG. 4 illustrates how this makes it possible to pull cables 24 for controlling the movements of the robot, such as for energy feed to motors and signal transmission in a path, sealed from the exterior, inside the robot from the base 1 to the upper arm 8 through the different axles. To this end, also the lower arm 4 is made hollow and sealed relative to the exterior via a removable housing 25 for accessing the interior of the lower arm. The “cables” may be of any kind, such as electric conductors, optical fibres, hoses for water and air, etc.

FIG. 5 shows how a tube 26 may be arranged to extend through the first axle 3 in order to pass so-called client cables 27 therein, that is, specific cables for the intended use of the robot, such as welding wires. The tube 26 has an outer diameter that is, smaller than the inner diameter of the axle 3 and the cables 24 for controlling the movements of the robot are arranged in the space between the outer wall of the tube 26 and the inner wall of the axle 3, so that these two types of cables do not influence each other.

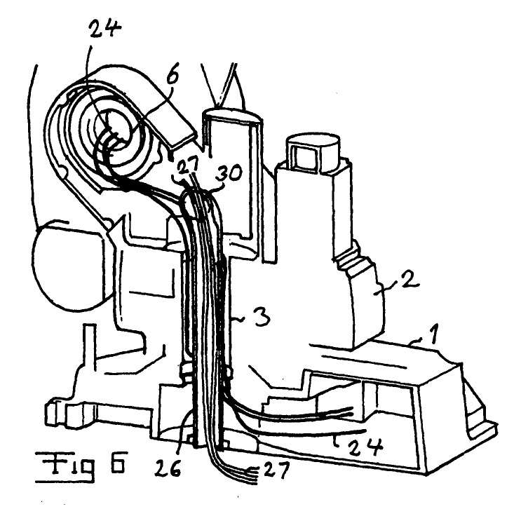

FIG. 6 shows how the so-called client cables 27 at 30 are passed out sideways from the stand of the robot and instead run externally thereof and possibly back into the robot stand in the region of the third shaft. In certain applications, such a cable pulling may lead to a longer service life of the cables, which may be of considerable importance from the point of view of economy.

The robot according to the invention as described above is very compact in its design and tight, especially watertight, and hence suitable for use in tough environments without expensive seals being required. It may then also be washed in a simple manner with water and/or other cleaning agents without this having a detrimental effect on the operation of the robot.

The invention is not, of course, in any way limited to the embodiments described above, but a plurality of possibilities of modifications thereof are obvious to a person skilled in the art, without this person therefore departing from the basic concept of the invention as defined in the accompanying claims.

For example, the multistage gear transmission in said drive packages could have more than two stages, for example three.

Nor is it necessary for the robot to exhibit any so-called client cables.

The mutual sequence shown in FIG. 2 for the gears of the drive packages for rotation about the first and second axes may, of course, be varied to some extent within the scope of the invention.

1. An industrial robot, comprising:
a fixed base,
a frame rotatably connected to the fixed base about a first hollow shaft,
a lower arm, one end of which is rotatably connected to the frame about a second hollow shaft,
an upper arm, one end of which is rotatably connected to the other end of the lower arm about a third shaft,
a drive package comprising a motor and a gear between the output shaft of the motor and the first and second shafts, respectively, wherein the respective gear is a multistage gear transmission with parallel gear wheel axes, wherein one of the gear wheels of the gear is secured to the first and second shafts, respectively, wherein the gear for the second shaft is arranged above the gear of the first shaft and, viewed from above in the direction of the first shaft, is partly covering the gear of the first shaft, and wherein the first and second shafts open out into a common space in the frame that forms both a stand part and a housing for the gears associated with the first and second shafts.

2. The industrial robot according to claim 1, wherein said gear wheel, which is fixed to the second shaft, is arranged externally of and passed through by the second shaft and protrudes, viewed from above in the direction of the first shaft, in the radial direction essentially up to said first shaft.

3. The industrial robot according to claim 1, wherein both of said drive packages are arranged inside said frame.

4. (canceled)

5. (canceled)

6. The industrial robot according to claim 1, wherein said space in the frame is outwardly sealed by a removable housing.

7. The industrial robot according to, claim 1, wherein also the third shaft and the lower arm are hollow, and wherein cables for controlling movements of the robot extend from the base to the upper arm inside the base, the frame and the lower arm through said three shafts in a path that is sealed relative to the exterior.

8. The industrial robot according to claim 7, wherein the lower arm comprises a housing arranged to be removable for accessing the interior of the lower arm.

9. The industrial robot according to claim 1, further comprising:
a said drive package with a motor and a multistage gear transmission also for said third shaft, wherein the drive package is arranged in a space in the upper arm together with a drive package with a motor and a gear for rotation of the upper arm relative to the lower arm about a fourth shaft that is parallel to the longitudinal extent of the upper arm.

10. The industrial robot according to claim 9, wherein said space in the upper arm is sealed relative to the exterior by a removable housing.

11. The industrial robot according to claim 9, wherein motors for shafts arranged at the other end of the upper arm, located opposite to the connection with the lower arm, are arranged in said space in the upper arm.

12. The industrial robot according to claim 1, further comprising:
client cables, extending from the interior of the base to the frame through said first shaft, said client cables being specific for the intended use of the robot, and which do not belong to cables intended for controlling movements of the robot.

13. The industrial robot according to claim 12, further comprising:
a tube, extending inside said first shaft in the direction thereof, with a smaller outer diameter than the inner diameter of the shaft, wherein said client cables are arranged in the tube and the cables intended for controlling the movements of the robot in the space between the tube and the inner wall of the shaft to sealingly separate these two types of cables.

14. The industrial robot according to further comprising:
for at least one of said gears, means for eliminating any play in the last stage of the gear in that said last gear wheel, which is secured to the respective shaft, and a penultimate gear wheel meshing therewith exhibit wedge-like teeth in the direction of their axes of rotation, and
means arranged for spring-loaded influence of said penultimate gear wheel in the direction of said axes of rotation to mesh with said last gear wheel.
